(19) United States
(12) Patent Application Publication
(10) Pub. No.: US 2005/0066527 A1
(43) Pub. Date: Mar. 31, 2005

(54) Razor and molding method for soluble lubricating member in razor

(75) Inventor: Yoshihiro Wakayama, Seki-shi (JP)

Correspondence Address: POSZ & BETHARDS, PLC, 11250 ROGER BACON DRIVE, SUITE 10, RESTON, VA, 20190, US

(73) Assignee: KAI R & D CENTER CO., LTD.

(21) Appl. No.: 10/950,382

(22) Filed: Sep. 28, 2004

(30) Foreign Application Priority Data
Sep. 30, 2003 (JP) 2003-341600

(51) Int. Cl. B26B 19/44

(52) U.S. Cl. 30/41

(57) ABSTRACT

A razor has a head portion to which a blade is mounted, and a soluble lubricating member which is, on the surface of the head portion, located on the upper side of the blade. An exposure surface of the soluble lubricating member is surrounded by a left end and right end extending in the direction of the edge of the blade, and front and rear edges that connect the left end and right end with each other, on both sides thereof in a widthwise direction of the blade. The exposure surface is composed of a plurality of sectional surfaces located between the left end and right end. The sectional surfaces include a maximum sectional surface having a maximum peak portion maximum in height on a predetermined reference plane of height.

### BACKGROUND OF THE INVENTION

The present invention relates to a razor provided with a soluble lubricating member on a surface of a head portion of the razor, to which head a blade is attached, and to a molding method for the soluble lubricating member in the razor.

Japanese Utility Model Publication No.7-48224 discloses a safety razor having a pair of blades. The blades are attached to a head portion of the razor. A lubricating strip as a soluble lubricating member is provided on the surface of the top plate.

In the above-described publication, however, since the surface of the lubricating strip is formed flat, when the surface of the lubricating strip is applied to the skin during use of the safety razor, almost the entire surface of the lubricating strip comes into contact with the skin without clearance. For this reason, it is difficult for water to enter and for the lubricating strip to dissolve between the skin and the surface of the lubricating strip, and it is difficult for the lubricating strip to accumulate on the surface in dissolved form. Therefore, when moving the head portion of the razor during use of the safety razor, the lubricating strip does not sufficiently function, and there is a possibility adverse impact on the shaving quality.

The above-described publication also discloses a method for integrally molding a lubricating strip with the top plate of a safety razor. According to this method, the lubricating strip is inserted into a mold. Then, resin for a top plate is injected into a cavity that faces the lubricating strip. When the resin for the top plate is injected, there is a possibility that the surface of the lubricating strip will be damaged due to pressure and heat from the resin for the top plate.

### SUMMARY OF THE INVENTION

It is an objective of the present invention to improve the shaving quality of a razor by enhancing the lubricating function of a soluble lubricating member, which functions as a lubricating strip. Another objective of the present invention is to prevent the surface of the head portion of a razor from being damaged when integrally molding the soluble lubricating member, which functions as a lubricating strip, with the surface of the head portion of a razor.

To achieve the foregoing and other objectives and in accordance with the purpose of the present invention, a razor comprising a head portion, a blade including an upper side and an edge, and a soluble lubricating member is provided. The blade is mounted on the head portion, with the soluble lubricating member located on the upper side of the blade. An exposure surface of the soluble lubricating member is surrounded by a left end and a right end separated from each other in the direction of the edge of the blade, and by a front edge and a rear edge connecting the left end and right end with each other. The left end and right end each include opposite sides and the front edge and rear edge of the exposure surface connecting both sides of each of the left end and right end, and also extend in the widthwise direction of the blade, which is orthogonal to a direction of thickness of the blade. The exposure surface includes a plurality of sectional surfaces located between the left end and right end. The sectional surfaces include a highest sectional surface having a peak portion maximum in height on a predetermined reference plane of height.

The present invention also provides a method for forming a soluble lubricating member in a razor. The method includes: forming a razor head portion of synthetic resin, with the razor head portion having a surface with an injection chamber formed thereon; supporting the razor head portion made of synthetic resin within a cavity of a mold die having an injection port; arranging the razor head portion such that the surface thereof is exposed; supplying the soluble lubricating member in a molten state to the cavity from the injection port of the mold die toward the injection chamber in a state in which the injection chamber formed on the surface of the razor head portion is opposed to the injection port of the mold die; and solidifying the soluble lubricating member.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a front view showing the main body of a T-shaped razor according to a preferred embodiment, in which the cap has been removed;

FIG. 1(b) is a side view showing the main body of the razor;

FIG. 1(c) is a rear view showing the main body of the razor;

FIG. 2(a) is an enlarged side sectional view showing the main body of the razor;

FIG. 2(b) is a sectional view taken along line 2B-2B of FIG. 2(a);

FIG. 3(a) is an enlarged plan view showing the main body of the razor;

FIG. 3(b) is a plan view showing the razor with a cap attached;

FIG. 4(a) is a partial enlarged sectional view taken along line 4A-4A of FIG. 3(a);

FIG. 4(b) is a partial enlarged sectional view taken along line 4B-4B of FIG. 3(a);

FIG. 4(c) is a partial sectional view of a metal mold, showing a molding process of a soluble lubricating member in the main body of the razor; and

FIG. 4(d) is another partial sectional view of a metal mold, showing a molding process of a soluble lubricating member in the main body of the razor.

### DETAILED DESCRIPTION OF THE PREFERRED EMBODIMENTS

Hereinafter, with reference to the drawings, description will be provided of a T-shaped razor according to an embodiment of the present invention.

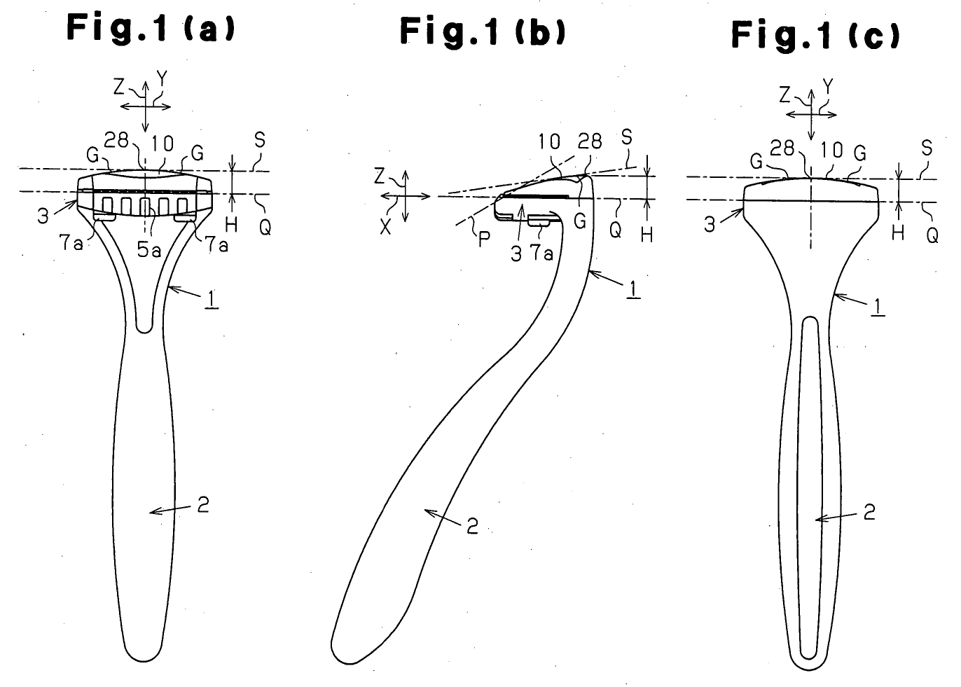

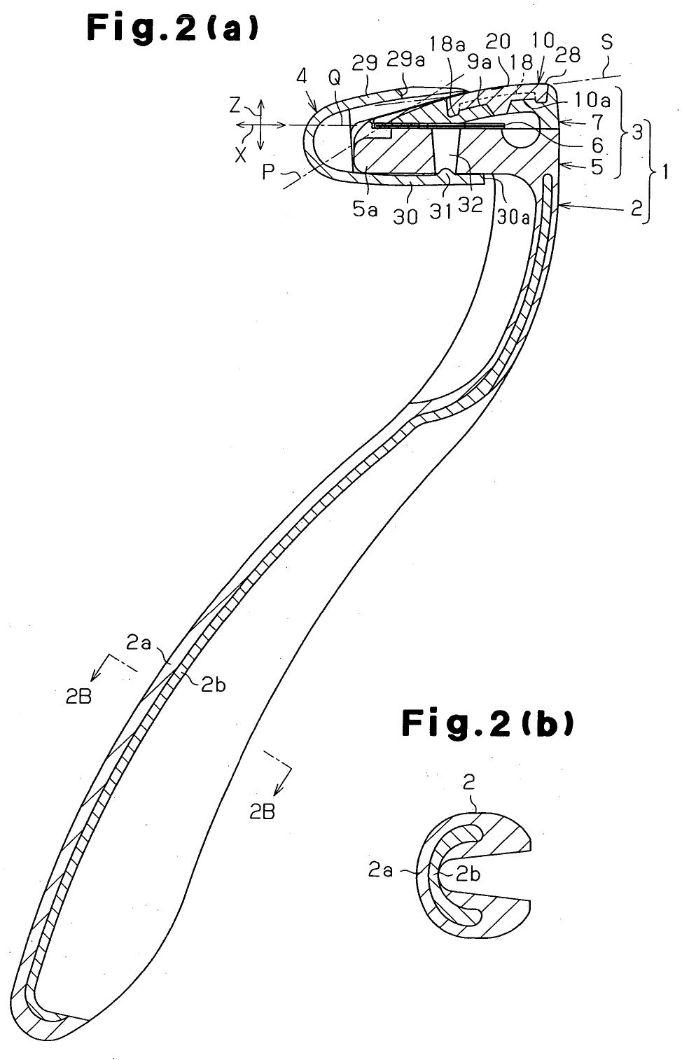

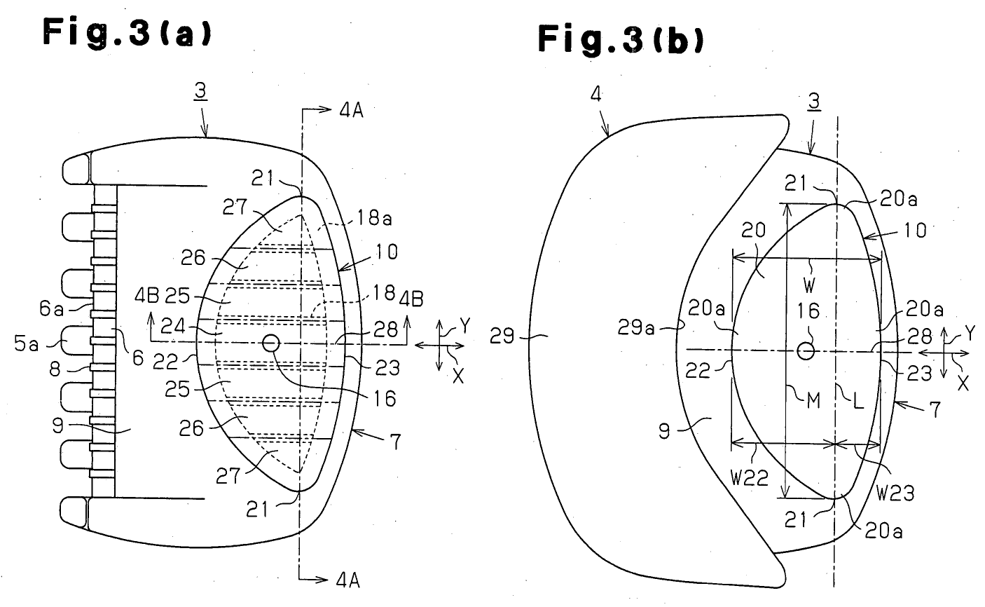

This T-shaped razor is composed of a main body 1 having a head portion 3 at the upper end of a holder 2 as shown in FIGS. 1(a), 1(b) and 1(c) and FIG. 3(a), and a cap 4 to cover this head portion 3 as shown in FIGS. 2(a) and 3(b). The head portion 3 is composed of a blade base 5 integrally molded with the holder 2, a blade 6 placed on this blade base 5, and a top plate 7. The plate 7 and the blade base 5 hold the the blade 6 therebetween.

Any of the holder 2, the blade base 5, the top plate 7 and the cap 4 is obtained by injection-molding using synthetic resin, hard synthetic resin such as, for example, acrylonitrile-butadiene-styrene (ABS), polypropylene and polystyrene. At the front end of the blade base 5, a plurality of guard portions 5a project forward in a comb shape, and arranged side-by-side (along the Y-direction) at intervals. As shown in FIG. 1(a), the thickness of the guard portions 5a along the up-and-down direction Z, or along the thickness of the blade 6 are set such that guard portions 5a at the center have a greater thickness in order to increase the strength of the guard portions 5a at the center, which are most likely to be applied to the skin S during use.

As shown in FIG. 3(a), the edge 6a of the blade 6 is, on the front side of the head portion 3, located above the guard portions 5a and exposed from between the blade base 5 and the top plate 7. To the edge 6a, a guard plate 8 made of synthetic resin is mounted. The guard portions 5a protrude more forwardly than the guard plate 8. In order to make the edge 6a difficult to be directly applied to the skin S between the guard portions 5a, a part of the guard plate 8 is located between the guard portions 5a. A shaving tangential line surface P connecting each guard portion 5a to the surface 9 of the top plate 7 passes the vicinity of the edge 6a of blade.

The holder 2 may be molded with resins with different colors. It is possible to appropriately select the color pattern from among various multicolor molding patterns. For example, as shown in FIGS. 2(a) and 2(b), a different color resin portion 2b may be embedded in a semitransparent resin portion 2a from the lower end of the holder 2 to the vicinity of the blade base 5, thereby emphasizing this feature in the external appearance of the holder 2.

On the surface 9 of the top plate 7, the soluble lubricating member 10, which is located above the blade 6, is injection-molded as described below.

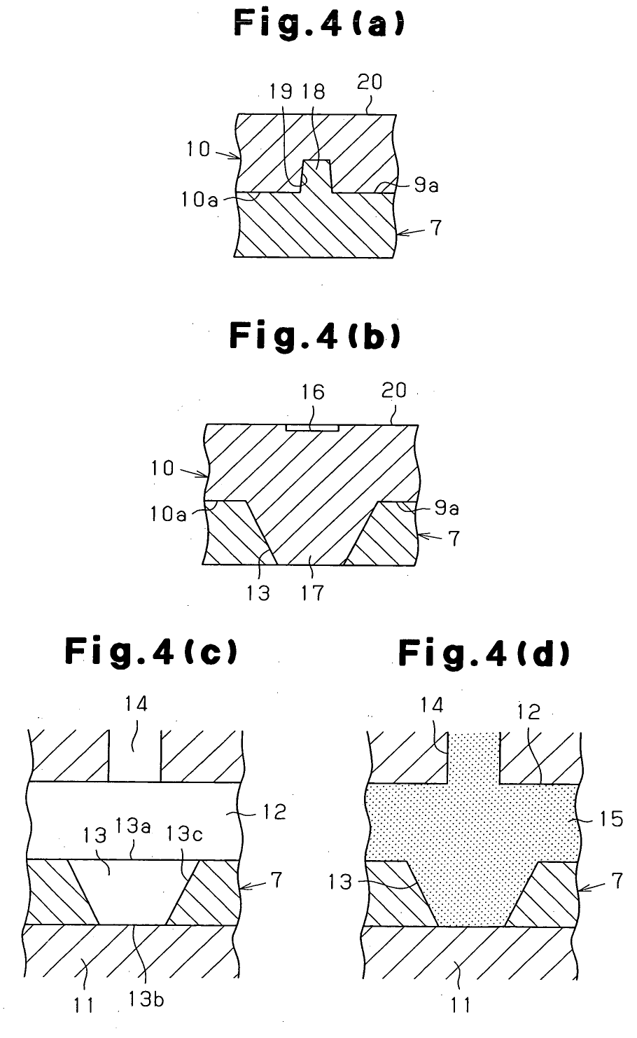

As shown in FIGS. 4(c), and 4(d), the top plate 7 is supported in a mold die 11, and the surface 9 of the top plate 7 is exposed in a cavity 12 within the mold die 11. In a state in which an injection chamber 13 formed in the top plate 7 is opposed to an injection port 14 of the mold die 11, molten resin 15 for forming the soluble lubricating member 10 is supplied from the injection port 14 to the cavity 12 and the injection chamber 13. The injection chamber 13 has an inside aperture 13a on a side close to the injection port 14, and an outside aperture 13b on a side distant. The diameter of an inner peripheral wall 13c between both apertures 13a, 13b is reduced in such a manner that its inner diameter becomes smaller toward the outside aperture 13b from the inside aperture 13a.

Part of the molten resin 15 supplied to the cavity 12 from the injection port 14 reverses to return to the cavity 12 after it reaches an inner peripheral wall 13c within the injection chamber 13. Within the mold die 11, the cavity 12 and the injection port 14 are filled with the molten resin 15. After the molten resin 15 solidifies, the mold die 11 is opened to take out the top plate 7, the back surface 10a of the soluble lubricating member 10 is placed on a placement surface, 9a of the surface 9 of the top plate 7, as shown in FIGS. 2(a) and 4(b).

Also, part of the molten resin 15 that has been charged into the injection port 14 and remains is cut off. At this time, a breakage portion 16 is formed. Adjacent to the breakage portion 16, a projecting portion 17 of the soluble lubricating member 10 having a shape corresponding to the injection chamber 13 is formed.

In the injection chamber 13, the outside aperture 13b may be omitted so that the injection chamber 13 has a bottom. Also, as shown in FIGS. 2(a), 3(a) and 4(a), on the placement surface 9a of the top plate 7, there is formed an annular groove portion 18a, inside which a plurality of projecting portions 18 extending along the back-and-forth direction, that is, along the X-direction are provided side by side at intervals along the Y-direction. Therefore, on the back surface 10a of the soluble lubricating member 10, there are formed recess portions 19 in which each projecting portion 18 fits. To the soluble lubricating member 10, there may be added additional agents such as amino acid, vitamin E, plant extract, aloe, tourmaline, silk powder, hair growth inhibitor, silver ion, copper ion, silicone oil, cosmetic liquid, and pharmaceutical drug. A weight ratio of the addition agents is 0.01 to 5%.

Front and rear edges 22, 23 connect left and right ends 21 with each other on both sides in a direction Y of the edge 6a of the blade 6 and in a widthwise direction X of the blade 6. The direction X is orthogonal to the direction Z. An exposure surface 20 of the soluble lubricating member 10 is surrounded by the front and rear edges 22, 23. Between the front and rear edges 22, 23, there are formed a plurality of sectional surfaces 24, 25, 26, 27. Each sectional surface 24, 25, 26, 27 is arranged side-by-side along the direction Y between the left and right ends 21, and is a portion partitioned by each of the recess portions 19.

An imaginary line L for connecting both ends 21 of the lubricating member 10 is supposed. In such a manner that the distance W22 between the front edge 22 of the lubricating member 10 and the imaginary line L becomes smaller toward both ends 21 from the central sectional surface 24, the lubricating member 10 bulges in a curve along the annular groove portion 18a toward the front from the imaginary line L.

In such a manner that the distance W23 between the rear edge 23 of the lubricating member 10 and the imaginary line L becomes smaller toward both ends 21 from the central sectional surface 24, the lubricating member 10 bulges in a curve along the annular groove portion 18a toward the rear from the imaginary line L. T width dimension of W (=W22+W23) of each sectional surface 24, 25, 26, 27 between the front edge 22 and the rear edge 23 in the back-and-forth direction becomes smaller towards both ends 21 from the central sectional surface 24. On the other hand, an interval M between both ends 21 is within a range of one to five times as long as the width dimension W of the central sectional surface 24. Further, the exposure surface 20 is, at both ends 21 and the front and rear edges 22, 23, connected to the surface 9 of the top plate 7 with a smooth, continuous surface 20a free from any difference in level. The continuous surface 20a is a curved surface which bulges upward in the direction Z, and smoothly connects the sectional surfaces 24, 25, 26 and 27 that are adjacent to each other.

Each of the sectional surfaces 24, 25, 26, 27 is inclined on a reference plane Q of height in such a manner that the height H on the reference plane Q of height becomes larger toward the rear side from the front side, of both sides in the X-direction. This reference plane Q for the height is an imaginary plane orthogonal to the direction of thickness (Z-direction) of the blade 6, and is regarded as a plane which passes through the edge 6a of the blade 6 for the sake of convenience.

The central sectional surface 24 is the widest sectional surface being maximum in the width dimension W between front and rear edges 22, 23, and is also the highest sectional surface having a peak portion 28 maximum in height H in the reference plane Q of height in the vicinity of the rear edge 23. The height H of each sectional surface 24, 25, 26, 27 becomes smaller toward both the left and right ends from the central sectional surface 24 as this widest sectional surface and highest sectional surface. The above-described breakage portion 16 is at a central position of the exposure surface 20 within this central sectional surface 24. In the exposure surface 20 of the lubricating member 10, the rear edge 23 slightly lowers toward the rear from this peak portion 28.

In a state in which the head portion 3 is covered with the cap 4 as shown in FIGS. 2(a) and 3(b), an inner edge 29a of an upper wall portion 29 of the cap 4 extends along the front edge 22 of the lubricating member 10 and a locking projection 31 of a lower wall portion 30 of the cap 4 is engaged into a locking hole 32 of the blade base 5. Also, an inner edge 30a of the lower wall portion 30 of the cap 4 is formed so as to avoid a crimping projection 7a of the top plate 7 shown in FIGS. 1(a), and 1(b).

When the exposure surface 20 of the lubricating member 10 is applied to the skin S to cause the central sectional surface 24 to come into contact with the skin S during use of the razor as shown in FIGS. 1(a), 1(c) and 3(a), a clearance G occurs between the skin S and the central sectional surface in a portion or the whole of smaller sectional surfaces 25, 26 and 27 in the height H than this central sectional surface 24. The maximum clearance G is caused by a difference h (not shown) between a height H28 (not shown) in the peak portion 28 of the central sectional surface 24 and a height H21 (not shown) in the left and right ends 21. The difference h has been set within a range of 0.1 mm≦h≦5 mm.

During use of the razor, water enters the clearance G, facilitating dissolving of the lubricating member 10, and distribution of the lubricating member 10 material dissolved therefrom and accumulated in the clearance G. When the lubricating member 10 gradually decreases as the razor is used, the projecting portion 18 of the top plate 7 is exposed so that the user is notified of the decrease. Also, when designing the razor, it may be possible to measure the ratio of decrease in the lubricating member 10 with respect to the number of times of use relative to data acquired in advance, and determine a thickness for the lubricating member 10 for covering the projecting portion 18 of the top plate 7 by referring to the data.

Although not shown, the exposure surface 20 of the lubricating member 10 may be a curved surface which is depressed downward, of both sides thereof with respect to the Z-direction. In that case, a sectional surface 27 including the left and right ends 21 becomes the highest sectional surface and the lowest sectional surface, and the central sectional surface 24 becomes the widest sectional surface and the lowest sectional surface, and the clearance G occurs between the left and right ends 21. Also, in the exposure surface 20 of the lubricating member 10, the external shape to be formed by the left and right ends 21 and the front and rear edges 22, 23 may be changed into various shapes such as an elliptic shape, and, for example, a curved surface having an external shape in which the sectional surface 27 including the left and right ends 21 becomes the lowest sectional surface and the widest sectional surface, and the central sectional surface 24 becomes the narrowest sectional surface and the highest sectional surface.

Next, the description will be made of the effect of the present embodiment together with the characteristic structure.

(1) As described above, in a razor according to the present embodiment, on the surface of the head portion 3 to which the blade 6 is mounted, there is provided the soluble lubricating member 10 on the upper side of the blade 6. The exposure surface 20 of this soluble lubricating member 10 is surrounded by both the left and right ends 21 extending in the direction Y of the edge 6a of the blade 6, and both front and rear edges 22, 23, which connect both the left and right ends 21 with each other on both sides extending direction Y of the blade and in the widthwise direction X of the blade 6, which direction X is orthogonal to the direction Z of the thickness. Also, the exposure surface 20 is composed of the sectional surfaces 24, 25, 26 and 27, which are arranged continuously to one another along the direction Y between the left and right ends 21 and are located between the front and rear edges 22, 23. The sectional surfaces 24, 25, 26 and 27 include the highest sectional surface 24 having the peak portion 28 in which the height H on the reference plane of height (for example, the imaginary plane Q orthogonal to the direction Z of the thickness of the blade 6) reaches a maximum. The edge 6a of this blade 6 is exposed on the front side of the head portion 3 forward of the soluble lubricating member 10.

Therefore, in this razor, when the exposure surface 20 of the soluble lubricating member 10 is applied to the skin S, the highest sectional surface 24 comes into contact with the skin S, and the clearance G occurs with the skin S on both sides or a single side of the highest sectional surface 24 in a portion or the whole of each sectional surface 25, 26 and 27 which is smaller in the height H than the highest sectional surface 24. For this reason, water enters the clearance G between the exposure surface 20 of the soluble lubricating member 10 and the skin S and, facilitates dissolving of the soluble lubricating member 10, and accumulation of the material dissolved from the lubricating member 10 in the clearance G. Therefore, when shaving the skin S by moving the head portion 3, the material dissolved from the soluble lubricating member 10 and accumulated, is easier to spread from the clearance G, and the lubricity is enhanced to improve shaving quality.

(2) Also, each of the sectional surfaces 24, 25, 26 and 27 is inclined toward the reference plane Q of height in such a manner that the height H on the reference plane Q becomes larger toward the rear side from the front side in the direction X of the width. Therefore, this inclination makes it easier for the soluble lubricating member 10 solved and accumulated to spread from the clearance G, and the lubricity is further enhanced to improve the shaving quality.

(3) The sectional surfaces 24, 25, 26 and 27 includes the widest sectional surface 24, in which the width dimension W between the front and rear edges 22, 23 reaches a maximum, and the widest sectional surface 24 and the highest sectional surface 24 coincide with each other. Since on the exposure surface 20 of the soluble lubricating member 10, the highest sectional surface 24, which is applied to the skin S exceedingly easily, is the widest sectional surface 24, the soluble lubricating member 10 can be effectively used.

(4) The widest and highest sectional surface 24 is located midway between the left and right ends 21 on the exposure surface 20 of the soluble lubricating member 10, and the width dimension W and the height H of the sectional surfaces 25, 26 and 27 become smaller toward the left and right ends 21 from the widest and highest sectional surface 24.

On the exposure surface 20 of the soluble lubricating member 10, the front edge 22 bulges toward the front from the imaginary line L in such a manner that the distance W22 between the front edge 22 and the imaginary line L for connecting between both the left and right ends 21 becomes smaller toward the left and right ends 21 from the widest and highest sectional surface 24. The rear edge 23 bulges toward the front from the imaginary line L in such a manner that the distance W23 between the rear edge 23 and the imaginary line L for connecting between both the left and right ends 21 becomes smaller toward the left and right ends 21 from the widest and highest sectional surface 24.

Since on the exposure surface 20 of the soluble lubricating member 10, the widest and highest sectional surface 24 have been set at an intermediate position between the left and right ends 21, the soluble lubricating member 10 most easily decreases at the intermediate position. Also, when shaving the skin S by moving the head portion 3 of the razor, the material dissolved from soluble lubricating member 10 and accumulated, easily spreads from the clearance G, so that the shaving quality is improved and the soluble lubricating member 10 can be further effectively used.

(5) The exposure surface 20 of the soluble lubricating member 10 is a curved surface bulging upward. In this case, when shaving the skin S by moving the head portion 3 of the razor, the feel of the razor head portion 3 to the surface 9 and the shaving quality are improved.

(6) The exposure surface 20 of the soluble lubricating member 10 is, in the left and right ends 21 and the front and rear edges 22, 23, connected to the surface 9 of the razor head portion 3 with a continuous surface 20a free from any difference in level. In this case, when shaving the skin S by moving the head portion 3 of the razor, the feel of the razor head portion 3 to the surface 9 and the shaving quality are improved.

(7) The back surface 10a of the soluble lubricating member 10 is placed on a placement surface 9a of the, surface 9 of the razor head portion 3. One of the pairs of the convex portions 18, 17 and the recess portions 19, 13, which overlap one another, is arranged on the back surface 10a of the soluble lubricating member 10, while the other pair is arranged on the placement surface 9a of the razor head portion 3. In this case, by means of the projecting portions 18, 17 and the recess portions 19, 13, the soluble lubricating member 10 is reliably fixed to the razor head portion 3.

(8) The soluble lubricating member 10 is molded as described below. In the cavity 12 within the mold die 11, the surface 9 of the razor head portion 3 is exposed by supporting the razor head portion 3 made of synthetic resin within the mold die 11. In this state, the soluble lubricating member 10 is supplied to the cavity 12 from the injection port 14 of the mold die 11 toward the injection chamber 13, while the injection chamber 13 formed on the surface 9 of the razor head portion 3 is opposed to the injection port 14 of the mold die 11.

The soluble lubricating member 10 provided on the surface 9 of the razor head portion 3, to which the blade 6 is mounted, is molded integrally with the razor head portion 3. Then, the back surface 10a of the lubricating member 10 is placed on the placement surface 9a of the razor head portion 3, and has the projecting portion 17 filled within the injection chamber 13. The resin remaining in the injection port 14 is removed, and the breakage portion 16 is formed in association with the removal. Adjacent to this breakage portion 16, the projecting portion 17 is arranged.

In this case, the soluble lubricating member 10 is molded integrally with the razor head portion 3 to be firmly fixed. Also, when the soluble lubricating member 10 supplied from the injection port 14 is charged into the injection chamber 13 as the projecting portion 17, shock is absorbed by the injection chamber 13. It is therefore possible to prevent the surface 9 of the razor head portion 3 from being damaged due to pressure and heat from the soluble lubricating member 10. As described above, it is not only possible to mold the soluble lubricating member 10 without damaging the razor head portion 3, but also it is possible to reduce variations in the lubricating function because in order to prevent the surface 9 of the razor head portion 3 from being damaged during molding, the soluble lubricating member 10 uniformly flows within the cavity 12 to render the soluble lubricating member 10 uniform.

The present examples and embodiments are to be considered as illustrative and not restrictive and the invention is not to be limited to the details given herein, but may be modified within the scope and equivalence of the appended claims.

1. A razor comprising:
a head portion, a blade including an upper side and an edge, and a soluble lubricating member, the blade being mounted on the head portion, with the soluble lubricating member located on the upper side of said blade, and an exposure surface of said soluble lubricating member surrounded by a left end and a right end separated from each other in the direction of the edge of said blade, and by a front edge and a rear edge connecting said left end and right end with each other, said left end and right end each including opposite sides and said front edge and rear edge of the exposure surface connecting both sides of each of the left end and right end, and also extending in the widthwise direction of said blade, which is orthogonal to a direction of thickness of said blade, and said exposure surface including a plurality of sectional surfaces located between said left end and right end, and said sectional surfaces including a highest sectional surface having a peak portion maximum in height on a predetermined reference plane of height.

2. The razor according to claim 1, wherein said sectional surfaces are inclined toward said reference plane of height in such a manner that the height on the reference plane of height becomes larger toward the rear side from the front side of said blade in the widthwise direction of the blade.

3. The razor according to claim 1, wherein said sectional surfaces include a widest sectional surface, on which a width dimension between said front edge and rear edge reaches a maximum, and said widest sectional surface and said highest sectional surface coincide with each other.

4. The razor according to claim 3, wherein said widest sectional surface and said highest sectional surface are located midway between said left end and right end on the exposure surface of said soluble lubricating member, and the width dimension and height of the sectional surfaces become smaller toward said left end and right end from said widest sectional surface and said highest sectional surface.

5. The razor according to claim 4, wherein on said exposure surface of said soluble lubricating member, a front edge of said soluble lubricating member is provided bulging toward the front more than an imaginary line connecting said left end and right end with each other, the bulging being in such a manner that distance between the front edge and said imaginary line becomes smaller toward said left end and right end from said widest sectional surface and said highest sectional surface, and wherein a rear edge of said soluble lubricating member bulges toward the rear more than said imaginary line in such a manner that distance between the rear edge and said imaginary line becomes smaller toward said left end and right end from said widest sectional surface and said highest sectional surface.

6. The razor according to claim 1, wherein said exposure surface of said soluble lubricating member is a curved surface that bulges upward.

7. The razor according to claim 1, wherein said exposure surface of said soluble lubricating member is, in the left end and right end and the front edge and rear edge thereof, connected to the surface of said razor head portion by a continuous surface.

8. The razor according to claim 1, wherein the head portion includes a placement surface, and said soluble lubricating member is placed on the placement surface, and wherein one of a convex portion and a recess portion, which overlap one another, is provided on said soluble lubricating member, while the other one is provided on said placement surface of said head portion.

9. The razor according to claim 2, wherein said sectional surfaces include a widest sectional surface, in which the width dimension between said front edge and rear edge reaches maximum, and said widest sectional surface and said highest sectional surface coincide with each other.

10. The razor according to claim 2, wherein said exposure surface of said soluble lubricating member is a curved surface that bulges upward.

11. The razor according to claim 2, wherein said exposure surface of said soluble lubricating member is, in the left end and right end and the front edge and rear edge thereof, connected to the surface of said razor head portion by a continuous surface.

12. The razor according to claim 2, wherein head portions includes a placement surface and said soluble lubricating member is placed on the placement surface, and wherein one of a convex portion and recess portion, which overlap one another, is provided on said soluble lubricating member, while the other one is provided on said placement surface of said head portion.

13. A method for forming a soluble lubricating member in a razor, the method comprising:
forming a razor head portion of synthetic resin, with the razor head portion having a surface with an injection chamber formed thereon;
supporting the razor head portion made of synthetic resin within a cavity of a mold die having an injection port;
arranging said razor head portion such that the surface thereof is exposed;
supplying said soluble lubricating member in a molten state to the cavity from the injection port of the mold die toward the injection chamber in a state in which the injection chamber formed on the surface of said razor head portion is opposed to the injection port of the mold die; and
solidifying said soluble lubricating member.

14. The method according to claim 13, further comprising cutting part of said soluble lubricating member that remains in the injection port of said mold die after solidification.
